(19) United States
(12) Patent Application Publication
(10) Pub. No.: US 2024/0163853 A1
(43) Pub. Date: May 16, 2024

(54) METHOD AND DEVICE USED FOR POSITIONING

(71) Applicants: Jin LIU, Shanghai (CN); Xiaobo ZHANG, Shanghai (CN)

(72) Inventors: Jin LIU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/508,263

(22) Filed: Nov. 14, 2023

(30) Foreign Application Priority Data
Nov. 15, 2022 (CN) 202211428176.8

(51) Int. Cl. H04W 72/0446; H04L 5/00; H04W 64/00

(52) U.S. Cl. CPC H04W 72/0446; H04L 5/0048; H04W 64/00

(57) ABSTRACT

A first node receives a first information block, the first information block is used to determine a first resource pool; transmits a first signaling, the first signaling is used to determine a first time-domain resource block from the first resource pool; transmits a first positioning reference signal on a first reference signal resource; the first reference signal resource belongs to the first time-domain resource block in time domain; a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource. Application enhances the resource utilization efficiency of the sidelink positioning reference signal resource pool.

### CROSS REFERENCE TO RELATED APPLICATIONS

This application claims the priority benefit of Chinese Patent Application No. 202211428176.8, filed on Nov. 15, 2022, the full disclosure of which is incorporated herein by reference.

### BACKGROUND

### Technical Field

The present application relates to transmission methods and devices in wireless communication systems, and in particular to a scheme and a device related to positioning in wireless communications.

### Related Art

Positioning is an important application in the wireless communication field; the emergence of new applications such as Vehicle to Everything (V2X) or the Industrial Internet of Things has put forward higher requirements for accuracy or delay of the positioning. At 3rd Generation Partner Project (3GPP) Radio Access Network (RAN) #94e meeting, a research topic on positioning enhancement was approved.

### SUMMARY

According to a work plan in NR Release-18 (Rel-18), NR Rel-18 requires enhanced positioning techniques that support Sidelink Positioning (SL Positioning), of which the mainstream sidelink positioning techniques comprise SL RTT-based technique, SL AOA, SL TDOA, and SL AOD, etc., and the execution of these techniques depends on the measurement of Sidelink Positioning Reference Signals (SL PRSs). According to 3GPP RANI #110bis meeting, a bandwidth of an SL PRS may be as large as a bandwidth of a resource pool, when a Physical Sidelink Control Channel (PSCCH) scheduling SL PRS resources is not frequency-division multiplexed with an SL PRS, it will result in a waste of a large amount of resources in a slot to which the PSCCH belongs, seriously affecting the utilization efficiency of the SL PRS resource pool.

To address the above problem, the present application provides a solution for positioning resource allocation. It should be noted that though the present application only took V2X scenario for example or as a typical scenario; the present application is also applicable to scenarios other than V2X confronting similar issues, such as Public Safety, Industrial Internet of Things, etc., where technical effects similar to NR V2X scenarios can be achieved. In addition, although the motivation of the present application is aimed at the scenario where a transmitter of a radio signal used for positioning measurement is mobile, the present application is still applicable to the scenario where a transmitter of a radio signal used for positioning measurement is fixed, such as Road Side Unit (RSU), etc. The adoption of a unified solution for various scenarios contributes to the reduction of hardware complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

If necessary, reference can be made to 3GPP standards TS38.211, TS38.212, TS38.213, TS38.214, TS38.215, TS38.321, TS38.331, TS38.305, TS37.355 to assist in the understanding the present application.

The present application provides a method in a first node for wireless communications, comprising:
receiving a first information block, the first information block being used to determine a first resource pool;
transmitting a first signaling, the first signaling being used to determine a first time-domain resource block from the first resource pool; and
transmitting a first positioning reference signal on a first reference signal resource;
herein, the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, a problem to be solved in the present application is: when a scheduling signaling of an SL PRS is multiplexed with SL PRS resources, the problem of low resource utilization efficiency incurred by a large bandwidth of the SL PRS.

In one embodiment, a problem to be solved in the present application is: a bandwidth of a PSCCH mismatching a bandwidth of an SL PRS results in a significant waste of resources in slots occupied by the PSCCH.

In one embodiment, a problem to be solved in the present application is: the problem of effective multiplexing between a control signaling and a positioning reference signal.

In one embodiment, a method in the present application is: establishing a relation between a location of a first signaling and a configuration of a first reference signal resource.

In one embodiment, a method in the present application is: establishing a relation between a locational relation between a first time-domain resource block and time-domain resources occupied by a first signaling in time domain and a configuration of a first reference signal resource.

In one embodiment, the method of the present application is conducive to an effective transmission of an SL PRS.

In one embodiment, the method of the present application increases the resource utilization efficiency of an SL PRS resource pool.

According to one aspect of the present application, characteristics of the above method is in that time-domain resources occupied by the first signaling in time domain belong to one of the multiple time-domain resource blocks comprised in the first resource pool, and whether the time-domain resources occupied by the first signaling in time domain belong to the first time-domain resource block is used to determine the configuration of the first reference signal resource.

According to one aspect of the present application, characteristics of the above method is in that a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

According to one aspect of the present application, characteristics of the above method is in that a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

According to one aspect of the present application, the above method is characterized in that the first resource pool comprises multiple frequency-domain resource blocks, and frequency-domain resources occupied by the first signaling in frequency domain belong to one of the multiple frequency-domain resource blocks comprised in the first resource pool; the configuration of the first reference signal resource is related to the frequency-domain resources occupied by the first signaling in frequency domain.

According to one aspect of the present application, the above method is characterized in that the first information block indicates a first period length; the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups.

According to one aspect of the present application, the above method is characterized in that the first time-domain resource block and the second time-domain resource block belong to a same first-type period among the multiple first-type periods.

According to one aspect of the present application, the above method is characterized in that the first node is a UE.

According to one aspect of the present application, the above method is characterized in that the first node is a relay node.

According to one aspect of the present application, the above method is characterized in that the first node is a roadside unit.

The present application provides a method in a second node for wireless communications, comprising:
receiving a second information block, the second information block being used to determine a first resource pool;
receiving a first signaling, the first signaling being used to determine a first time-domain resource block from the first resource pool; and
receiving a first positioning reference signal on a first reference signal resource;
herein, the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

According to one aspect of the present application, characteristics of the above method is in that time-domain resources occupied by the first signaling in time domain belong to one of the multiple time-domain resource blocks comprised in the first resource pool, and whether the time-domain resources occupied by the first signaling in time domain belong to the first time-domain resource block is used to determine the configuration of the first reference signal resource.

According to one aspect of the present application, characteristics of the above method is in that a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

According to one aspect of the present application, characteristics of the above method is in that a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

According to one aspect of the present application, the above method is characterized in that the first resource pool comprises multiple frequency-domain resource blocks, and frequency-domain resources occupied by the first signaling in frequency domain belong to one of the multiple frequency-domain resource blocks comprised in the first resource pool; the configuration of the first reference signal resource is related to the frequency-domain resources occupied by the first signaling in frequency domain.

According to one aspect of the present application, the above method is characterized in that the second information block indicates a first period length; the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups.

According to one aspect of the present application, the above method is characterized in that the first time-domain resource block and the second time-domain resource block belong to a same first-type period among the multiple first-type periods.

According to one aspect of the present application, the above method is characterized in that the second node is a UE.

According to one aspect of the present application, the above method is characterized in that the second node is a relay node.

According to one aspect of the present application, the above method is characterized in that the second node is a roadside unit.

The present application provides a first node for wireless communications, comprising:
a first receiver, receiving a first information block, the first information block being used to determine a first resource pool;
a first transmitter, transmitting a first signaling, the first signaling being used to determine a first time-domain resource block from the first resource pool; and
the first transmitter, transmitting a first positioning reference signal on a first reference signal resource;
herein, the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

The present application provides a second node for wireless communications, comprising:
a second receiver, receiving a second information block, the second information block being used to determine a first resource pool;
a third receiver, receiving a first signaling, the first signaling being used to determine a first time-domain resource block from the first resource pool;
the third receiver, receiving a first positioning reference signal on a first reference signal resource;
herein, the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a structure diagram of UE positioning according to one embodiment of the present application;

FIG. 6 illustrates a flowchart of a radio signal transmission according to one embodiment of the present application;

FIG. 7 illustrates a schematic diagram of a relation between a configuration of a first reference signal resource as well as a first time-domain resource block and time-domain resources occupied by a first signaling in time domain according to one embodiment of the present application;

FIG. 8 illustrates a schematic diagram of a relation between a configuration of a first reference signal resource as well as a first time-domain resource block and time-domain resources occupied by a first signaling in time domain according to one embodiment of the present application;

FIG. 9 illustrates a schematic diagram of a relation between a first-type period and control channel resources according to one embodiment of the present application;

FIG. 10 illustrates a structure block diagram of a processor in a first node according to one embodiment of the present application;

FIG. 11 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

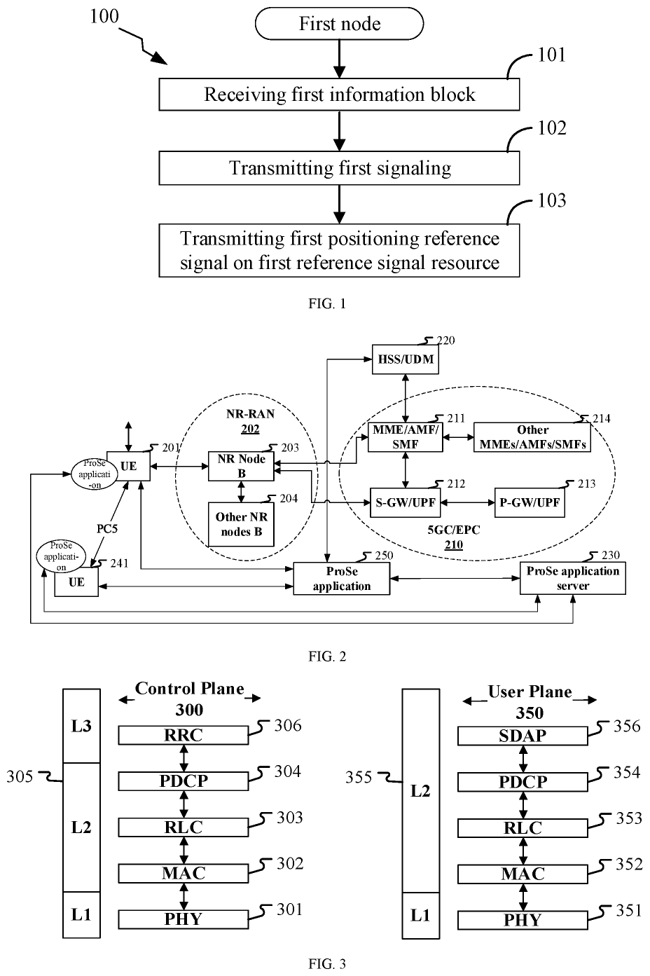

Embodiment 1 illustrates a flowchart of the processing of a first node according to one embodiment of the present application, as shown in FIG. 1. In FIG. 1, each block represents a step.

In Embodiment 1, a first node in the present application firstly receives a first information block in step S101; then transmits a first signaling in step 102; finally transmits a first positioning reference signal on a first reference signal resource in step 103; the first information block is used to determine a first resource pool; the first signaling is used to determine a first time-domain resource block from the first resource pool; the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, the first resource pool comprises a sidelink resource pool.

In one embodiment, the first resource pool is used for sidelink transmission.

In one embodiment, the first resource pool is used for sidelink communications.

In one embodiment, the first resource pool is used for Sidelink Positioning.

In one embodiment, the first resource pool is used for Sidelink Positioning Reference Signal (SL-PRS) transmission.

In one embodiment, the first resource pool is dedicated for SL-PRS transmission.

In one embodiment, the first resource pool is used for SL-PRS and Sidelink Control Information (SCI) transmission.

In one embodiment, the first resource pool comprises a Physical Sidelink Control Channel (PSCCH).

In one embodiment, the first resource pool comprises a Physical Sidelink Shared Channel (PSSCH).

In one embodiment, the first resource pool comprises SL-PRS resources.

In one embodiment, the first resource pool comprises PSCCH and SL-PRS resources.

In one embodiment, the first resource pool comprises PSCCH, PSSCH and SL-PRS resources.

In one embodiment, the first resource pool comprises multiple Resource Elements (REs).

In one embodiment, any RE in the first resource pool occupies a multicarrier symbol in time domain and a subcarrier in frequency domain.

In one embodiment, the first resource pool comprises multiple time-frequency resource blocks.

In one embodiment, any of the multiple time-frequency resource blocks comprised in the first resource pool comprises multiple REs.

In one embodiment, the first resource pool comprises multiple time-domain resource blocks in time domain.

In one embodiment, the first resource pool comprises multiple frequency-domain resource blocks in frequency domain.

In one embodiment, time-domain resources occupied by any of the multiple time-frequency resource blocks comprised in the first resource pool in time domain are one of the multiple time-domain resource blocks comprised in the first resource pool in time domain.

In one embodiment, time-domain resources occupied by the multiple time-frequency resource blocks comprised in the first resource pool in time domain are respectively the multiple time-domain resource blocks comprised in the first resource pool in time domain.

In one embodiment, frequency-domain resources occupied by any of the multiple time-frequency resource blocks comprised in the first resource pool in frequency domain are one of the multiple frequency-domain resource blocks comprised in the first resource pool in frequency domain.

In one embodiment, frequency-domain resources occupied by the multiple time-frequency resource blocks comprised in the first resource pool in frequency domain are respectively the multiple frequency-domain resource blocks comprised in the first resource pool in frequency domain.

In one embodiment, time-domain resources occupied by any of the multiple time-frequency resource blocks comprised in the first resource pool in time domain belong to a time-domain resource block in the first resource pool, and frequency-domain resources occupied by any of the multiple time-frequency resource blocks comprised in the first resource pool in frequency domain belong to a frequency-domain resource block in the first resource pool.

In one embodiment, the multiple time-domain resource blocks comprised in the first resource pool in time domain are respectively multiple slots.

In one embodiment, the multiple time-domain resource blocks comprised in the first resource pool in time domain are respectively multiple multicarrier symbols.

In one embodiment, any of the multiple time-domain resource blocks comprised in the first resource pool in time domain belongs to a slot.

In one embodiment, any of the multiple time-domain resource blocks comprised in the first resource pool in time domain comprises at least one multicarrier symbol.

In one embodiment, the multiple frequency-domain resource blocks comprised in the first resource pool in frequency domain are respectively multiple sub-channels.

In one embodiment, the multiple frequency-domain resource blocks comprised in the first resource pool in frequency domain are respectively multiple Resource Blocks (RBs).

In one embodiment, the multiple frequency-domain resource blocks comprised in the first resource pool in frequency domain are respectively multiple Physical Resource Blocks (PRBs).

In one embodiment, any of the multiple frequency-domain resource blocks comprised in the first resource pool in frequency domain belongs to a sub-channel.

In one embodiment, any of the multiple frequency-domain resource blocks comprised in the first resource pool in frequency domain belongs to an RB.

In one embodiment, any of the multiple frequency-domain resource blocks comprised in the first resource pool in frequency domain belongs to a PRB.

In one embodiment, any of the multiple frequency-domain resource blocks comprised in the first resource pool in frequency domain comprises at least one subcarrier.

In one embodiment, any of the multiple frequency-domain resource blocks comprised in the first resource pool in frequency domain comprises at least one RB.

In one embodiment, any of the multiple frequency-domain resource blocks comprised in the first resource pool in frequency domain comprises at least one PRB.

In one embodiment, the multiple time-domain resource blocks comprised in the first resource pool in time domain are respectively multiple slots, and the multiple frequency-domain resource blocks comprised in the first resource pool in frequency domain are respectively multiple PRBs.

In one embodiment, the first resource pool comprises the first time-domain resource block.

In one embodiment, the first time-domain resource block is one of the multiple time-domain resource blocks comprised in the first resource pool.

In one embodiment, the first time-domain resource block comprises at least one slot.

In one embodiment, the first time-domain resource block is a slot.

In one embodiment, the first time-domain resource block comprises multiple multicarrier symbols.

In one embodiment, the multicarrier symbol is an Orthogonal Frequency Division Multiplexing (OFDM) symbol.

In one embodiment, the multicarrier symbol is a Single-Carrier Frequency-Division Multiple Access (SC-FDMA) symbol.

In one embodiment, the multicarrier symbol is a Discrete Fourier Transform Spread Orthogonal Frequency Division Multiplexing (DFT-S-OFDM) symbol.

In one embodiment, the multicarrier symbol is an Interleaved Frequency Division Multiple Access (IFDMA) symbol.

In one embodiment, the first information block is used to indicate the first resource pool.

In one embodiment, the first information block comprises the first resource pool.

In one embodiment, the first information block is used to indicate time-domain resources occupied by the first resource pool.

In one embodiment, the first information block comprises time-domain resources occupied by the first resource pool.

In one embodiment, the first information block is used to indicate frequency-domain resources occupied by the first resource pool.

In one embodiment, the first information block comprises frequency-domain resources occupied by the first resource pool.

In one embodiment, the first information block is used to indicate the multiple time-frequency resource blocks comprised in the first resource pool.

In one embodiment, the first information block comprises the multiple time-frequency resource blocks comprised in the first resource pool.

In one embodiment, the first information block is used to indicate the multiple time-domain resource blocks comprised in the first resource pool in time domain.

In one embodiment, the first information block comprises the multiple time-domain resource blocks comprised in the first resource pool in time domain.

In one embodiment, the first information block is used to indicate the multiple frequency-domain resource blocks comprised in the first resource pool in frequency domain.

In one embodiment, the first information block comprises the multiple frequency-domain resource blocks comprised in the first resource pool in frequency domain.

In one embodiment, the first information block is pre-configured.

In one embodiment, the first information block is configured.

In one embodiment, the first information block is configured by a higher-layer signaling.

In one embodiment, the first information block comprises a higher-layer signaling.

In one embodiment, the first information block comprises a Radio Resource Control (RRC) layer signaling.

In one embodiment, the first information block comprises a Radio Resource Control-Information Element (RRC-IE).

In one embodiment, the first information block comprises a Multimedia Access Control (MAC) layer signaling.

In one embodiment, the first information block comprises a Physical Layer (PHY) signaling.

In one embodiment, the first information block comprises Downlink Control Information (DCI).

In one embodiment, the first information block comprises Sidelink Control Information (SCI).

In one embodiment, the first information block is a System Information Block (SIB).

In one embodiment, the first information block is a Positioning SIB (posSIB).

In one embodiment, for the definition of the posSIB, refer to Chapter 6.3.1a of 3GPP TS38.331.

In one embodiment, the first information block is SIB12.

In one embodiment, for the definition of the SIB12, refer to Chapter 6.3.1 of 3GPP TS38.331.

In one embodiment, the first information block comprises Sidelink Positioning Configuration.

In one embodiment, the first information block comprises Sidelink Communication Configuration.

In one embodiment, the first information block comprises Sidelink Discovery Configuration.

In one embodiment, the first information block comprises an SL-ResourcePool.

In one embodiment, for the definition of the SL ResourcePool, refer to Chapter 6.3.5 of 3GPP TS38.331.

In one embodiment, the first signaling is used to indicate the first time-domain resource block.

In one embodiment, the first signaling indicates an index of the first time-domain resource block.

In one embodiment, the first signaling is used to indicate the first time-domain resource block from the first resource pool.

In one embodiment, the first signaling is used to indicate the first time-domain resource block from the multiple time-domain resource blocks comprised in the first resource pool.

In one embodiment, the first signaling indicates an index of the first time-domain resource block in the first resource pool.

In one embodiment, the first signaling comprises a higher-layer signaling.

In one embodiment, the first signaling comprises a physical-layer signaling.

In one embodiment, the first signaling comprises an SCI.

In one embodiment, the first signaling is an SCI.

In one embodiment, the first signaling is a 1st-stage SCI.

In one embodiment, the first signaling comprises a PSCCH.

In one embodiment, the first signaling is a PSCCH.

In one embodiment, the first signaling comprises a PSSCH.

In one embodiment, the first signaling is carried on a PSCCH.

In one embodiment, the first signaling is carried on a PSSCH.

In one embodiment, the first signaling is carried on a PSCCH and a PSSCH.

In one embodiment, time-domain resources occupied by the first signaling in time domain comprise at least one multicarrier symbol.

In one embodiment, time-domain resources occupied by the first signaling in time domain comprise two multicarrier symbols.

In one embodiment, time-domain resources occupied by the first signaling in time domain comprise three multicarrier symbols.

In one embodiment, time-domain resources occupied by the first signaling in time domain belong to a time-domain resource block in the first resource pool.

In one embodiment, time-domain resources occupied by the first signaling in time domain belong to a slot.

In one embodiment, one time-domain resource block in the first resource pool comprises time-domain resources occupied by the first signaling in time domain.

In one embodiment, time-domain resources occupied by the first signaling in time domain belong to a first time-domain resource block, and the first time-domain resource block is one of the multiple time-domain resource blocks comprised in the first resource pool.

In one embodiment, time-domain resources occupied by the first signaling in time domain belong to a second time-domain resource block, and the second time-domain resource block is one of the multiple time-domain resource blocks comprised in the first resource pool.

In one embodiment, the second time-domain resource block is different from the first time-domain resource block.

In one embodiment, the second time-domain resource block is before the first time-domain resource block.

In one embodiment, the second time-domain resource block is earlier than the first time-domain resource block.

In one embodiment, the time-domain resources occupied by the first signaling in time domain belong to one of the first time-domain resource block or the second time-domain resource block.

In one embodiment, the first time-domain resource block comprises the time-domain resources occupied by the first signaling in time domain.

In one embodiment, the second time-domain resource block comprises the time-domain resources occupied by the first signaling in time domain.

In one embodiment, the first time-domain resource block comprises the at least one multicarrier symbol comprised in the time-domain resources occupied by the first signaling in time domain.

In one embodiment, the second time-domain resource block comprises the at least one multicarrier symbol comprised in the time-domain resources occupied by the first signaling in time domain.

In one embodiment, any of the at least one multicarrier symbol comprised in the time-domain resources occupied by the first signaling in time domain is a multicarrier symbol in the first time-domain resource block.

In one embodiment, any of the at least one multicarrier symbol comprised in the time-domain resources occupied by the first signaling in time domain is a multicarrier symbol in the second time-domain resource block.

In one embodiment, frequency-domain resources occupied by the first signaling in frequency domain comprise multiple PRBs.

In one embodiment, frequency-domain resources occupied by the first signaling in frequency domain comprise 10 PRBs.

In one embodiment, frequency-domain resources occupied by the first signaling in frequency domain comprise 25 PRBs.

In one embodiment, frequency-domain resources occupied by the first signaling in frequency domain belong to a frequency-domain resource block in the first resource pool.

In one embodiment, frequency-domain resources occupied by the first signaling in frequency domain belong to a subchannel.

In one embodiment, one frequency-domain resource block in the first resource pool comprises frequency-domain resources occupied by the first signaling in frequency domain.

In one embodiment, the first reference signal resource comprises multiple REs.

In one embodiment, the first reference signal resource comprises multiple REs in the first resource pool.

In one embodiment, the first reference signal resource comprises multiple subcarriers in frequency domain.

In one embodiment, the first reference signal resource comprises at least one PRB in frequency domain.

In one embodiment, the first reference signal resource comprises at least one subchannel in frequency domain.

In one embodiment, any two adjacent subcarriers comprised in the first reference signal resource in frequency domain differ N subcarrier(s), N being a positive integer.

In one embodiment, any two adjacent subcarriers comprised in the first reference signal resource in frequency domain are spaced by N−1 subcarrier(s), N being a positive integer.

In one embodiment, a comb size of the first reference signal resource is N.

In one embodiment, the comb size of the first reference signal resource is a number of subcarrier(s) that differs between any two adjacent subcarriers comprised in the first reference signal resource in frequency domain.

In one embodiment, N is one of 1, 2, 4, 6, 8 and 12.

In one embodiment, N is equal to 1.

In one embodiment, N is equal to 12.

In one embodiment, the first reference signal resource comprises at least one multicarrier symbol in time domain.

In one embodiment, the first reference signal resource comprises at least two continuous multicarrier symbols in time domain.

In one embodiment, the first reference signal resource comprises M continuous multicarrier symbol(s) in time domain, M being a positive integer.

In one embodiment, a number of symbol(s) of the first reference signal resource is M.

In one embodiment, the number of symbol(s) of the first reference signal resource is a number of multicarrier symbol(s) comprised in the first reference signal resource in time domain.

In one embodiment, the number of symbol(s) of the first reference signal resource is a number of the multiple multicarrier symbols comprised in the first reference signal resource in time domain.

In one embodiment, M is equal to the N.

In one embodiment, M is less than the N.

In one embodiment, M is greater than the N.

In one embodiment, M is one of 2, 4, 6, 8 or 12.

In one embodiment, M is equal to 2.

In one embodiment, M is equal to 12.

In one embodiment, the first reference signal resource is used to carry the first positioning reference signal.

In one embodiment, the first reference signal resource is time-frequency resources occupied by the first positioning reference signal.

In one embodiment, the first reference signal resource is REs occupied by the first positioning reference signal.

In one embodiment, the first reference signal resource is an SL-PRS resource.

In one embodiment, the first reference signal resource is a Sidelink Channel State Information Reference Signal (SL-CSI-RS) resource.

In one embodiment, the first reference signal resource is a PSSCH Demodulation Reference Signal (DMRS) resource.

In one embodiment, the first reference signal resource belongs to a time-domain resource block in the first resource pool in time domain.

In one embodiment, the first reference signal resource belongs to a slot in time domain.

In one embodiment, one time-domain resource block in the first resource pool comprises time-domain resources comprised in the first reference signal resource in time domain.

In one embodiment, the first reference signal resource belongs to the first time-domain resource block in time domain, and the first time-domain resource block is one of the multiple time-domain resource blocks comprised in the first resource pool.

In one embodiment, time-domain resources comprised in the first reference signal resource in time domain belong to the first time-domain resource block.

In one embodiment, the first time-domain resource block comprises time-domain resources comprised in the first reference signal resource in time domain.

In one embodiment, the first time-domain resource block comprises the M multicarrier symbol(s) comprised by the first reference signal resource in time domain.

In one embodiment, any of the M multicarrier symbol(s) comprised in the first reference signal resource in time domain is a multicarrier symbol in the first time-domain resource block.

In one embodiment, the first reference signal resource belongs to a frequency-domain resource block in the first resource pool in frequency domain.

In one embodiment, the first reference signal resource belongs to a subchannel in frequency domain.

In one embodiment, the first reference signal resource belongs to a resource pool in frequency domain.

In one embodiment, a frequency-domain resource block in the first resource pool comprises frequency-domain resources occupied by the first reference signal resource in frequency domain.

In one embodiment, the first resource pool comprises frequency-domain resources occupied by the first reference signal resource in frequency domain.

In one embodiment, the first positioning reference signal is used for positioning.

In one embodiment, the first positioning reference signal is used for sidelink positioning.

In one embodiment, the first positioning reference signal is used for obtaining first location information.

In one embodiment, the first positioning reference signal is used for obtaining an Rx-Tx Time Difference.

In one embodiment, the first positioning reference signal is used for obtaining a sidelink Rx-Tx Time Difference.

In one embodiment, the first positioning reference signal is used for obtaining a UE Rx-Tx Time Difference.

In one embodiment, the first positioning reference signal is used for obtaining Rx timing of the first positioning reference signal.

In one embodiment, the first positioning reference signal is used by a receiver of the first positioning reference signal to obtain Rx timing of a subframe.

In one embodiment, the first positioning reference signal is used by a receiver of the first positioning reference signal to obtain Rx timing of a slot.

In one embodiment, the first positioning reference signal is used for Positioning measurement.

In one embodiment, the first positioning reference signal is used for Sidelink positioning measurement.

In one embodiment, the first positioning reference signal is used for obtaining Angle-of-Arrival (AoA).

In one embodiment, the first positioning reference signal is used for obtaining Reference Signal Received Power (RSRP).

In one embodiment, the first positioning reference signal is used for obtaining Reference Signal Received Path Power (RSRPP).

In one embodiment, the first positioning reference signal is used for obtaining a Reference Signal Time Difference (RSTD).

In one embodiment, the first positioning reference signal is used for obtaining a Relative Time of Arrival (RTOA).

In one embodiment, the first positioning reference signal is used for obtaining SL-RTOA.

In one embodiment, the first positioning reference signal is used for RTT positioning.

In one embodiment, the first positioning reference signal is used for Single-sided RTT positioning.

In one embodiment, the first positioning reference signal is used for Double-sided RTT positioning.

In one embodiment, the first positioning reference signal is configured by a Location Management Function (LMF).

In one embodiment, the first positioning reference signal is configured by a g-Node-B (gNB).

In one embodiment, the first positioning reference signal is configured by a cell.

In one embodiment, the first positioning reference signal is configured by a UE.

In one embodiment, the first positioning reference signal comprises a Sidelink Reference Signal (SL RS).

In one embodiment, the first positioning reference signal comprises a Sidelink Positioning Reference Signal (SL PRS).

In one embodiment, the first positioning reference signal comprises a Sounding Reference Signal (SRS).

In one embodiment, the first positioning reference signal comprises a Sidelink Primary Synchronization Signal (S-PSS).

In one embodiment, the first positioning reference signal comprises a Sidelink Secondary Synchronization Signal (S-SSS).

In one embodiment, the first positioning reference signal comprises a Physical Sidelink Broadcast Channel Demodulation Reference Signal (PSBCH DMRS).

In one embodiment, the first positioning reference signal comprises a Sidelink Channel State Information-Reference Signal (SL CSI-RS).

In one embodiment, the first positioning reference signal comprises a first sequence.

In one embodiment, a first sequence is used to generate the first positioning reference signal.

In one embodiment, the first sequence is a Pseudo-Random Sequence.

In one embodiment, the first sequence is a Gold sequence.

In one embodiment, the first sequence is a Zadeoff-Chu (ZC) sequence.

In one embodiment, the first sequence obtains the first positioning reference signal after sequentially through Sequence Generation, Discrete Fourier Transform (DFT), Modulation and Resource Element Mapping, and wideband symbol generation.

In one embodiment, the first sequence obtains the first positioning reference signal after sequentially through sequence generation, resource element mapping and wideband symbol generation.

In one embodiment, the configuration of the first reference signal resource comprises at least one configuration parameter.

In one embodiment, the configuration of the first reference signal resource comprises multiple configuration parameters.

In one embodiment, the configuration of the first reference signal resource comprises the at least one multicarrier symbol comprised in the first reference signal resource in time domain.

In one embodiment, the configuration of the first reference signal resource comprises the number of symbol(s) of the first reference signal resource.

In one embodiment, the number of symbol(s) of the first reference signal resource is a configuration parameter in the configuration of the first reference signal resource.

In one embodiment, the configuration of the first reference signal resource comprises an index of the at least one multicarrier symbol comprised in the first reference signal resource in time domain in the first time-domain resource block.

In one embodiment, the configuration of the first reference signal resource comprises an index of the at least one multicarrier symbol comprised in the first reference signal resource in time domain in multiple multicarrier symbols in the first time-domain resource block.

In one embodiment, the configuration of the first reference signal resource comprises a time-domain location of the first reference signal resource in the first time-domain resource block.

In one embodiment, the time-domain location of the first reference signal resource in the first time-domain resource block is a configuration parameter in the configuration of the first reference signal resource.

In one embodiment, the time-domain location of the first reference signal resource in the first time-domain resource block refers to a multicarrier symbol occupied by the first reference signal resource in the first time-domain resource block.

In one embodiment, the time-domain location of the first reference signal resource in the first time-domain resource block refers to an index of any multicarrier symbol occupied by the first reference signal resource in the first time-domain resource block.

In one embodiment, the time-domain location of the first reference signal resource in the first time-domain resource block refers to an index in the first time-domain resource block of any multicarrier symbol occupied by the first reference signal resource in the first time-domain resource block.

In one embodiment, the time-domain location of the first reference signal resource in the first time-domain resource block refers to an index of any multicarrier symbol occupied by the first time-domain resource block in the first time-domain resource block in the multiple multicarrier symbols comprised in the first time-domain resource block.

In one embodiment, the time-domain location of the first reference signal resource in the first time-domain resource block refers to a location of the first reference signal resource in a first one of multicarrier symbols among multicarrier symbols occupied in the first time-domain resource block.

In one embodiment, the time-domain location of the first reference signal resource in the first time-domain resource block refers to an index in the first time-domain resource block of a first one of multicarrier symbols in multicarrier symbols occupied by the first reference signal resource in the first time-domain resource block.

In one embodiment, the configuration of the first reference signal resource comprises at least one of the number of multicarrier symbol(s) comprised by the first reference signal resource in time domain or the time-domain location of the first reference signal resource in the first time-domain resource block.

In one embodiment, the configuration of the first reference signal resource comprises at least one of the number of multicarrier symbol(s) comprised by the first reference signal resource in time domain or the time-domain location of the first reference signal resource in the first time-domain resource block.

In one embodiment, the configuration of the first reference signal resource comprises the number of multicarrier symbol(s) comprised by the first reference signal resource in time domain and the time-domain location of the first reference signal resource in the first time-domain resource block.

In one embodiment, the number of multicarrier symbol(s) comprised by the first reference signal resource in time domain and the time-domain location of the first reference signal resource in the first time-domain resource block are respectively one configuration parameter in the configuration of the first reference signal resource.

In one embodiment, the configuration of the first reference signal resource comprises at least one of a resource pattern of the first reference signal resource, a comb size of the first reference signal resource, a number of symbol(s) of the first reference signal resource, a number of frequency-domain resource block(s) occupied by the first reference signal resource, a resource repetition factor of the first reference signal resource, a transmission period of the first reference signal resource, or a maximum transmit power value of a signal transmitted on the first reference signal resource.

In one embodiment, the configuration of the first reference signal resource comprises the resource pattern of the first reference signal resource.

In one embodiment, the resource pattern of the first reference signal resource comprises Full-staggered pattern.

In one embodiment, the resource pattern of the first reference signal resource comprises Partial-staggered pattern.

In one embodiment, the resource pattern of the first reference signal resource comprises Unstaggered pattern.

In one embodiment, the configuration of the first reference signal resource comprises the comb size of the first reference signal resource.

In one embodiment, the configuration of the first reference signal resource comprises the number of symbol(s) of the first reference signal resource.

In one embodiment, the configuration of the first reference signal resource comprises the number of frequency-domain resource block(s) occupied by the first reference signal resource.

In one embodiment, the configuration of the first reference signal resource comprises the resource repetition factor of the first reference signal resource.

In one embodiment, the configuration of the first reference signal resource comprises the transmission period of the first reference signal resource.

In one embodiment, the configuration of the first reference signal resource comprises the maximum transmit power value of a signal transmitted on the first reference signal resource.

In one embodiment, the configuration of the first reference signal resource comprises time-frequency resources occupied by the first reference signal resource.

In one embodiment, the configuration of the first reference signal resource comprises time-domain resources occupied by the first reference signal resource.

In one embodiment, the configuration of the first reference signal resource comprises frequency-domain resources occupied by the first reference signal resource.

In one embodiment, the configuration of the first reference signal resource comprises a number of time-domain resource block(s) occupied by the first reference signal resource.

In one embodiment, the configuration of the first reference signal resource comprises REs occupied by the first reference signal resource.

In one embodiment, the configuration of the first reference signal resource comprises a number of RE(s) occupied by the first reference signal resource.

In one embodiment, the resource pattern of the first reference signal resource is one of the multiple configuration parameters comprised in the configuration of the first reference signal.

In one embodiment, the comb size of the first reference signal resource is one of the multiple configuration parameters comprised in the configuration of the first reference signal.

In one embodiment, the number of symbol(s) of the first reference signal resource is one of the multiple configuration parameters comprised in the configuration of the first reference signal.

In one embodiment, the number of frequency-domain resource block(s) occupied by the first reference signal resource is one of the multiple configuration parameters comprised in the configuration of the first reference signal.

In one embodiment, the resource repetition factor of the first reference signal resource is one of the multiple configuration parameters comprised in the configuration of the first reference signal.

In one embodiment, the transmission period of the first reference signal resource is one of the multiple configuration parameters comprised in the configuration of the first reference signal.

In one embodiment, the maximum transmit power value of a signal transmitted on the first reference signal resource is one of the multiple configuration parameters comprised in the configuration of the first reference signal.

In one embodiment, the time-frequency resources occupied by the first reference signal resource are one of the multiple configuration parameters comprised in the configuration of the first reference signal.

In one embodiment, the time-domain resources occupied by the first reference signal resource are one of the multiple configuration parameters comprised in the configuration of the first reference signal.

In one embodiment, the frequency-domain resources occupied by the first reference signal resource is one of the multiple configuration parameters comprised in the configuration of the first reference signal.

In one embodiment, the number of time-domain resource block(s) occupied by the first reference signal resource is one of the multiple configuration parameters comprised in the configuration of the first reference signal.

In one embodiment, the REs occupied by the first reference signal resource is one of the multiple configuration parameters comprised in the configuration of the first reference signal.

In one embodiment, the number of RE(s) occupied by the first reference signal resource is one of the multiple configuration parameters comprised in the configuration of the first reference signal.

In one embodiment, the first location information is reported to a Location Management Function (LMF).

In one embodiment, the first location information is transmitted to a transmitter of the first positioning reference signal.

In one embodiment, the first location information is reported to an LMF by a transmitter of the first positioning reference signal

In one embodiment, the first location information is transmitted to the first node in the present application.

In one embodiment, the first location information is reported to an LMF by the first node in the present application.

In one embodiment, the first location information is used to determine a Round Trip Time (RTT).

In one embodiment, the first location information is used by an LMF to determine an RTT.

In one embodiment, the first location information is used for positioning.

In one embodiment, the first location information is used for Location related measurement.

In one embodiment, the first location information is used for Sidelink positioning.

In one embodiment, the first location information is used for determining a Propagation Delay.

In one embodiment, the first location information is used by the LMF to determine a Propagation Delay.

In one embodiment, the first location information is used for RTT positioning.

In one embodiment, the first location information is used for Single-sided RTT positioning.

In one embodiment, the first location information is used for Double-sided RTT positioning.

In one embodiment, the first location information is used for Multiple-Round Trip Time (Multi-RTT) positioning.

In one embodiment, the first location information comprises a first Rx-Tx Time Difference.

In one embodiment, measuring the first positioning reference signal obtains the first Rx-Tx Time Difference.

In one embodiment, measuring the first positioning reference signal obtains the first location information.

In one embodiment, the first Rx-Tx Time Difference is used to generate the first location information.

In one embodiment, the first location information comprises Location related measurements.

In one embodiment, the first location information comprises Location estimate.

In one embodiment, the first location information comprises positioning Assistance Data.

In one embodiment, the first location information comprises TimingQuality.

In one embodiment, the first location information comprises RxBeamIndex.

In one embodiment, the first location information comprises received power information.

In one embodiment, the first location information is used to transfer Non-Access-Stratum (NAS) specific information.

In one embodiment, the first location information is used to transfer timing information of the clock.

In one embodiment, the received power information comprises Reference Signal Received Power (RSRP) of the first positioning reference signal.

In one embodiment, the received power information comprises Reference Signal Received Path Power (RSRPP) of the first positioning reference signal.

In one embodiment, the received power information comprises RSRP-ResultDiff.

In one embodiment, the received power information is measured by dBm.

In one embodiment, the received power information is measured by dB.

In one embodiment, the first Rx-Tx Time Difference comprises a Reference Signal Time Difference (RSTD).

In one embodiment, the first Rx-Tx Time Difference comprises Sidelink Rx-Tx Time Difference.

In one embodiment, the first Rx-Tx Time Difference comprises UE Rx-Tx Time Difference.

In one embodiment, the first Rx-Tx Time Difference comprises RxTxTimeDiff.

In one embodiment, the first Rx-Tx Time Difference comprises SL-RxTxTimeDiff.

In one embodiment, the first Rx-Tx Time Difference comprises Relative Time of Arrival (RTOA).

In one embodiment, the first Rx-Tx Time Difference comprises SL-RTOA.

### Embodiment 2

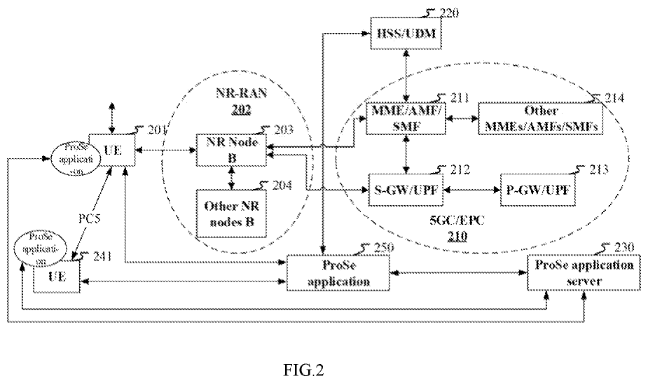

Embodiment 2 illustrates a schematic diagram of a network architecture according to one embodiment of the present application, as shown in FIG. 2. FIG. 2 is a diagram illustrating a V2X communication architecture of 5G NR, Long-Term Evolution (LTE), and Long-Term Evolution Advanced (LTE-A) systems. The 5G NR or LTE network architecture may be called a 5G System/Evolved Packet System (5GS/EPS) 200 or other appropriate terms.

The V2X communication architecture in Embodiment 2 may comprise a UE 201, a UE 241 in communication with UE 201, an NG-RAN 202, a 5G Core Network/Evolved Packet Core (5GC/EPC) 210, a Home Subscriber Server (HSS)/Unified Data Management (UDM) 220, a ProSe feature 250 and a ProSe application server 230. The V2X communication architecture may be interconnected with other access networks. For simple description, the entities/interfaces are not shown. As shown in FIG. 2, the V2X communication architecture provides packet switching services. Those skilled in the art will readily understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS). The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC Pro Se user ID as well as allocating ProSe-restricted code-suffix pool.

In one embodiment, the UE 201 and the UE 241 are in a connection via a PC5 Reference Point.

In one embodiment, the ProSe feature 250 is respectively connected with the UE 201 and the UE 241 via a PC3 Reference Point.

In one embodiment, the ProSe feature 250 is connected with the ProSe application server 230 via a PC2 Reference Point.

In one embodiment, the ProSe application server 230 is respectively connected with the ProSe application of the UE 201 and the ProSe application of the UE 241 via a PC1 Reference Point.

In one embodiment, the first node in the present application is the UE 201, and the second node in the present application is the UE 241.

In one embodiment, the first node in the present application is the UE 241, and the second node in the present application is the UE 201.

In one embodiment, a radio link between the UE 201 and the UE 241 corresponds to Sidelink (SL) in the present application.

In one embodiment, a radio link between the UE 201 and the NR node B is uplink.

In one embodiment, a radio link between the NR node B and the UE 201 is downlink.

In one embodiment, the UE 201 supports SL transmission.

In one embodiment, the UE 241 supports SL transmission.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a RoadSide Unit (RSU).

In one embodiment, the gNB 203 comprises satellite equipment.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE or RSU in V2X, vehicle equipment or On-Board Communication Unit) and a second node (gNB, UE or RSU in V2X, vehicle equipment or On-Board Communication Unit), or between two UEs is represented by three layers, which are respectively layer 1, layer 2 and layer 3. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection and provides support for handover of a first node between second nodes. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel. The MAC sublayer 302 is also responsible for allocating between first nodes various radio resources (i.e., resource block) in a cell. The MAC sublayer 302 is also responsible for HARQ operations. In the control plane 300, the RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 305, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first positioning reference signal in the present application is generated by the PHY 301.

### Embodiment 4

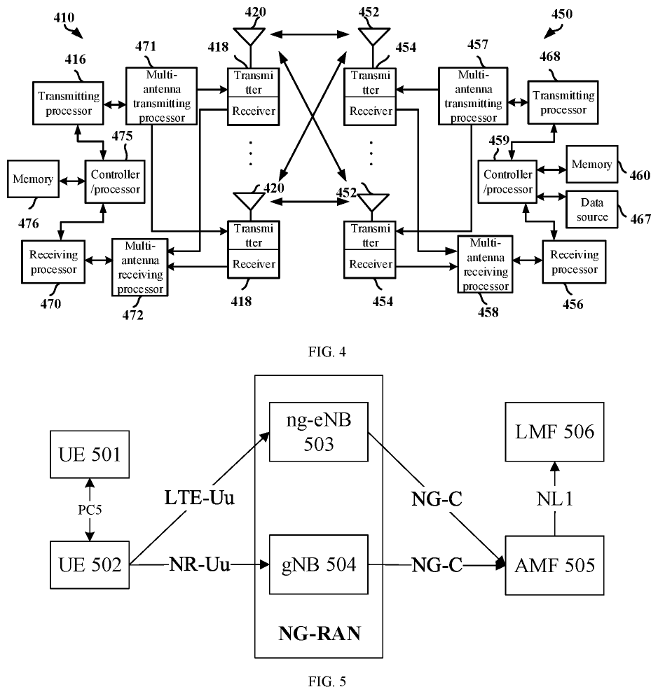

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first information block, the first information block is used to determine a first resource pool; transmits a first signaling, the first signaling is used to determine a first time-domain resource block from the first resource pool; transmits a first positioning reference signal on a first reference signal resource; the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, the second communication device 450 comprises a memory that stores a computer readable instruction program. The computer readable instruction program generates an action when executed by at least one processor. The action includes: receiving a first information block, the first information block being used to determine a first resource pool; transmitting a first signaling, the first signaling being used to determine a first time-domain resource block from the first resource pool; transmitting a first positioning reference signal on a first reference signal resource; the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: receives a second information block, the second information block is used to determine a first resource pool; receives a first signaling, the first signaling is used to determine a first time-domain resource block from the first resource pool; receives a first positioning reference signal on a first reference signal resource; herein, the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, the first communication device 410 comprises a memory that stores a computer readable instruction program. The computer readable instruction program generates an action when executed by at least one processor. The action includes: receiving a second information block, the second information block being used to determine a first resource pool; receiving a first signaling, the first signaling being used to determine a first time-domain resource block from the first resource pool; receiving a first positioning reference signal on a first reference signal resource; herein, the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, the second communication device 450 corresponds to the first node in the present application.

In one embodiment, the first communication device 410 corresponds to the second node in the present application.

In one embodiment, the second communication device 450 is a UE.

In one embodiment, the first communication device 410 is a UE.

In one embodiment, the second communication device 450 is an RSU.

In one embodiment, the first communication device 410 is an RSU.

In one embodiment, at least one of the antenna 452, the receiver 454, the multi-antenna receiving processor 458, the receiving processor 456, the controller/processor 459, or the memory 460 is used to receive a first information block in the present application.

In one embodiment, at least one of the antenna 452, the transmitter 454, the multi-antenna transmitting processor 457, the transmitting processor 468, the controller/processor 459, the memory 460, or the data sources 467 is used to transmit a first signaling in the present application.

In one embodiment, at least one of the antenna 452, the transmitter 454, the multi-antenna transmitting processor 457, the transmitting processor 468, the controller/processor 459, the memory 460, or the data source 467 is used to transmit a first positioning reference signal on a first reference signal resource in the present application.

In one embodiment, at least one of the antenna 420, the receiver 418, the multi-antenna receiving processor 472, the receiving processor 470, the controller/processor 475, or the memory 476 is used to receive a second information block in the present application.

In one embodiment, at least one of the antenna 420, the receiver 418, the multi-antenna receiving processor 472, the receiving processor 470, the controller/processor 475, or the memory 476 is used to receive a first signaling in the present application.

In one embodiment, at least one of the antenna 420, the receiver 418, the multi-antenna receiving processor 472, the receiving processor 470, the controller/processor 475, or the memory 476 is used to receive a first positioning reference signal on a first reference signal resource in the present application.

### Embodiment 5

Embodiment 5 illustrates a structure diagram of UE positioning according to one embodiment of the present application, as shown in FIG. 5.

The UE 501 is in communications with the UE 502 via a PC5 interface; the UE 502 is in communications with the ng-eNB 503 or the gNB 504 via a Long Term Evolution (LTE)-Uu interface or a New Radio (NR)-Uu new radio interface; the ng-eNB 503 and the gNB 504 are sometimes referred to as base stations, while the ng-eNB 503 and the gNB 504 are also referred to as Next Generation-Radio Access Network (NG-RAN). The ng-eNB 503 and the gNB 504 are respectively in a connection with the Authentication Management Field (AMF) 505 through Next Generation-Control plane (NG-C); the AMF 505 is in a connection with Location Management Function (LMF) 506 via an NL1 interface.

The AMF 505 receives a location service request associated with a specific UE from another entity, such as Gateway Mobile Location Centre (GMLC) or UE, or the AMF 505 itself decides to initiate a location service associated with the specific UE; then the AMF 505 transmits a location service request to an LMF, such as the LMF 506; then this LMF processes the location service request, comprising transmitting auxiliary data to the specific UE to assist UE-based positioning or UE-assisted positioning, and comprising receiving location information reported from the UE; then the LMF returns the result of the location service to the AMF 505; if the location service is requested by another entity, the AMF 505 returns the result of the location service to that entity.

In one embodiment, the network device in the present application comprises LMF.

In one embodiment, the network device in the present application comprises NG-RAN and LMF.

In one embodiment, the network device in the present application comprises NG-RAN, AMF and LMF.

### Embodiment 6

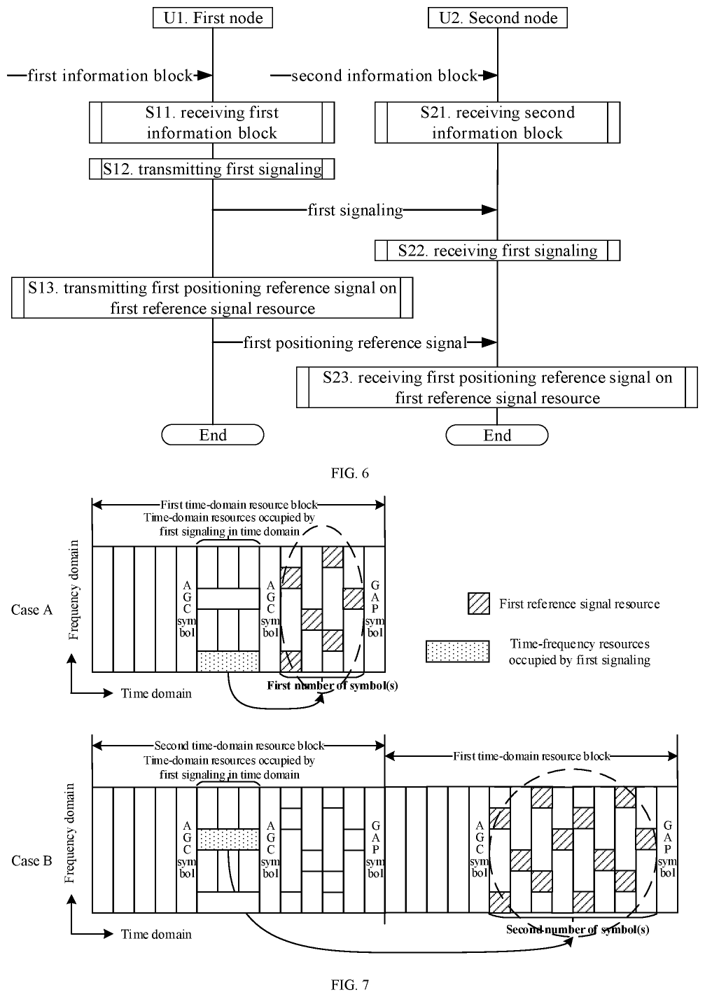

Embodiment 6 illustrates a flowchart of radio signal transmission according to one embodiment of the present application, as shown in FIG. 6. In FIG. 6, a first node U1 and a second node U2 are in communications via an air interface.

The first node U1 receives a first information block in step S11; transmits a first signaling in step S12; transmits a first positioning reference signal on a first reference signal resource in step S13.

The second node U2 receives a second information block in step S21; receives a first signaling in step S22; receives a first positioning reference signal on a first reference signal resource in step S23.

In embodiment 6, the first information block is used by the first node U1 to determine a first resource pool, and the second information block is used by the second node U2 to determine a first resource pool; the first resource pool comprises multiple time-domain resource blocks, a first time-domain resource block is one of the multiple time-domain resource blocks comprised in the first resource pool, and the first reference signal resource belongs to the first time-domain resource block in time domain; the first signaling is used to determine the first time-domain resource block from the first resource pool; the first reference signal resource comprises at least one multicarrier symbol in time domain; a configuration of the first reference signal resource is related to a locational relation between the first time-domain resource block and time-domain resources occupied by the first signaling in time domain; the configuration of the first reference signal resource comprises at least one of a number of symbol(s) for the first reference signal resource and a time-domain location of the first reference signal resource in the first time-domain resource block; a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; the first resource pool comprises multiple frequency-domain resource blocks, and frequency-domain resources occupied by the first signaling in frequency domain belong to one of the multiple frequency-domain resource blocks comprised in the first resource pool; the configuration of the first reference signal resource is related to the frequency-domain resources occupied by the first signaling in frequency domain; the first information block indicates a first period length; the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups; the first time-domain resource block and the second time-domain resource block belong to a same first-type period among the multiple first-type periods.

In one embodiment, when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

In one embodiment, the number of symbol(s) of the first reference signal resource is a first number of symbol(s); or, the number of symbol(s) of the first reference signal resource is a second number of symbol(s); the first number of symbol(s) is less than the second number of symbol(s).

In one embodiment, the time-domain resources occupied by the first signaling in time domain belong to the first time-domain resource block, the number of symbol(s) of the first reference signal resource is a first number of symbol(s); or, the time-domain resources occupied by the first signaling in time domain belong to the second time-domain resource block, the number of symbol(s) of the first reference signal resource is a second number of symbol(s); the first number of symbol(s) is less than the second number of symbol(s).

In one embodiment, when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

In one embodiment, a time-domain location of the first reference signal resource in the first time-domain resource block is a first time-domain location; or, a time-domain location of the first reference signal resource in the first time-domain resource block is a second time-domain location; the second time-domain location is earlier than the first time-domain location.

In one embodiment, the time-domain resources occupied by the first signaling in time domain belong to the first time-domain resource block, a time-domain location of the first reference signal resource in the first time-domain resource block is a first time-domain location; or, the time-domain resources occupied by the first signaling in time domain belong to the second time-domain resource block, and a time-domain location of the first reference signal resource in the first time-domain resource block is a second time-domain location; the second time-domain location is earlier than the first time-domain location.

In one embodiment, the first positioning reference signal is used for SL positioning.

In one embodiment, the first node U1 and the second node U2 are in communications via a PC5 interface.

In one embodiment, the second node U2 transmits the first location information to the first node U1.

In one embodiment, the second node U2 transmits the first location information to the first node U1, and the first node U1 reports the first location information to an LMF.

In one embodiment, the second node U2 reports the first position information to an LMF.

In one embodiment, the second information block is used to indicate the first resource pool.

In one embodiment, the second information block comprises the first resource pool.

In one embodiment, the second information block is used to indicate time-domain resources occupied by the first resource pool.

In one embodiment, the second information block comprises time-domain resources occupied by the first resource pool.

In one embodiment, the second information block is used to indicate frequency-domain resources occupied by the first resource pool.

In one embodiment, the second information block comprises frequency-domain resources occupied by the first resource pool.

In one embodiment, the second information block is used to indicate the multiple time-frequency resource blocks comprised in the first resource pool.

In one embodiment, the second information block comprises the multiple time-frequency resource blocks comprised in the first resource pool.

In one embodiment, the second information block is used to indicate the multiple time-domain resource blocks comprised in the first resource pool in time domain.

In one embodiment, the second information block comprises the multiple time-domain resource blocks comprised in the first resource pool in time domain.

In one embodiment, the second information block is used to indicate the multiple frequency-domain resource blocks comprised in the first resource pool in frequency domain.

In one embodiment, the second information block comprises the multiple frequency-domain resource blocks comprised in the first resource pool in frequency domain.

In one embodiment, the second information block is pre-configured.

In one embodiment, the second information block is configured.

In one embodiment, the second information block is configured by a higher-layer signaling.

In one embodiment, the second information block comprises a higher-layer signaling.

In one embodiment, the second information block comprises an RRC-layer signaling.

In one embodiment, the second information block comprises an RRC-IE.

In one embodiment, the second information block comprises a MAC-layer signaling.

In one embodiment, the second information block comprises a PHY signaling.

In one embodiment, the second information block comprises a DCI.

In one embodiment, the second information block comprises an SCI.

In one embodiment, the second information block is an SIB.

In one embodiment, the second information block is a posSIB.

In one embodiment, the second information block comprises sidelink positioning configuration.

In one embodiment, the second information block comprises sidelink communication configuration.

In one embodiment, the second information block comprises sidelink discovery configuration.

In one embodiment, the second information block comprises an SL-ResourcePool.

### Embodiment 7

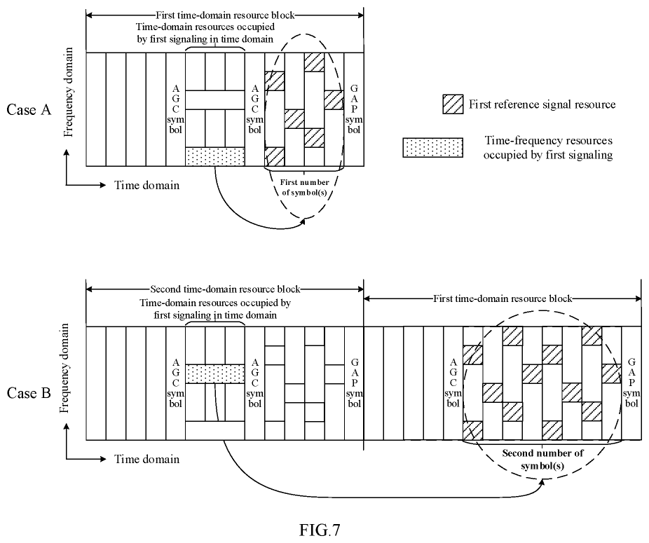

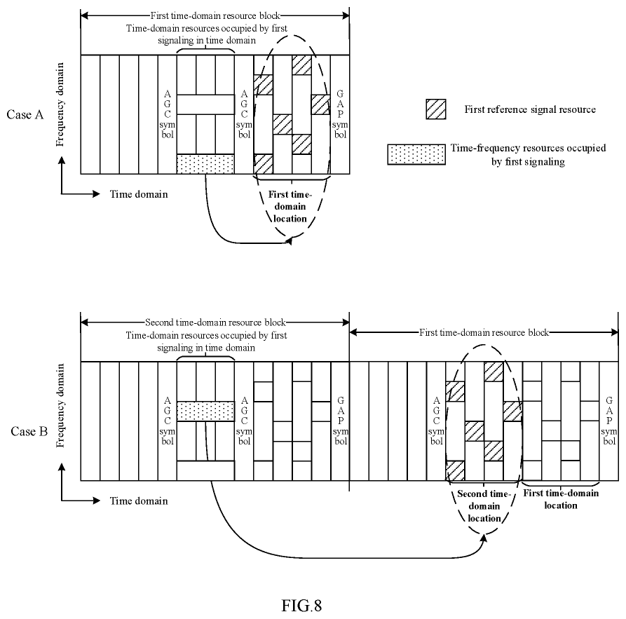

Embodiment 7 illustrates a schematic diagram of a relation between a configuration of a first reference signal resource as well as a first time-domain resource block and time-domain resources occupied by a first signaling in time domain according to one embodiment of the present application, as shown in FIG. 7. In FIG. 7, the long rectangle marked by “AGC symbol” represents a multicarrier symbol used for Automatic Gain Control (AGC); the long rectangle marked by “GAP symbol” represents a guard interval; the dot-filled rectangle represents time-frequency resources occupied by the first signaling; the slash-filled square represents an RE occupied by the first reference signal resource.

In embodiment 7, the first resource pool comprises the first time-domain resource block; time-domain resources comprised in the first reference signal resource belong to the first time-domain resource block; time-domain resources occupied by the first signaling in time domain belong to a time-domain resource block in the first resource pool; a configuration of a first reference signal resource comprises a number of symbol(s) of the first reference signal resource, and the number of symbol(s) of the first reference signal resource is related to a locational relation between the first time-domain resource block and the time-domain resources occupied by the first signaling in time domain; in case A of embodiment 7, the time-domain resources occupied by the first signaling in time domain belong to the first time-domain resource block, and a number of symbol(s) of the first reference signal resource is a first number of symbol(s); in case B of embodiment 7, the time-domain resources occupied by the first signaling in time domain belong to the second time-domain resource block, and a number of symbol(s) of the first reference signal resource is a second number of symbol(s); the first number of symbol(s) is less than the second number of symbol(s).

In one embodiment, the locational relation between the first time-domain resource block and the time-domain resources occupied by the first signaling in time domain comprises whether the time-domain resources occupied by the first signaling in time domain belong to the first time-domain resource block.

In one embodiment, the locational relation between the first time-domain resource block and the time-domain resources occupied by the first signaling in time domain refers to whether the time-domain resources occupied by the first signaling in time domain belong to the first time-domain resource block.

In one embodiment, the locational relation between the first time-domain resource block and the time-domain resources occupied by the first signaling in time domain comprises that the time-domain resources occupied by the first signaling in time domain belong to the first time-domain resource block.

In one embodiment, the locational relation between the first time-domain resource block and the time-domain resources occupied by the first signaling in time domain comprises that the time-domain resources occupied by the first signaling in time domain do not belong to the first time-domain resource block.

In one embodiment, the locational relation between the first time-domain resource block and the time-domain resources occupied by the first signaling in time domain comprises that the time-domain resources occupied by the first signaling in time domain belong to a time-domain resource block different from the first time-domain resource block in the first resource pool.

In one embodiment, the locational relation between the first time-domain resource block and the time-domain resources occupied by the first signaling in time domain comprises that the time-domain resources occupied by the first signaling in time domain belong to a second time-domain resource block, the second time-domain resource block is a time-domain resource block in the first resource pool, and the second time-domain resource block is different from the first time-domain resource block.

In one embodiment, the locational relation between the first time-domain resource block and the time-domain resources occupied by the first signaling in time domain comprises that the time-domain resources occupied by the first signaling in time domain belong to a second time-domain resource block, the second time-domain resource block is a time-domain resource block in the first resource pool, and the second time-domain resource block is before the first time-domain resource block.

In one embodiment, the locational relation between the first time-domain resource block and the time-domain resources occupied by the first signaling in time domain refers to whether the first time-domain resource block comprises the time-domain resources occupied by the first signaling in time domain.

In one embodiment, the locational relation between the first time-domain resource block and the time-domain resources occupied by the first signaling in time domain comprises that the first time-domain resource block comprises the time-domain resources occupied by the first signaling in time domain.

In one embodiment, the locational relation between the first time-domain resource block and the time-domain resources occupied by the first signaling in time domain comprises that the first time-domain resource block does not comprise the time-domain resources occupied by the first signaling in time domain.

In one embodiment, the locational relation between the first time-domain resource block and the time-domain resources occupied by the first signaling in time domain comprises that the second time-domain resource block comprises the time-domain resources occupied by the first signaling in time domain, and the second time-domain resource block is different from the first time-domain resource block.

In one embodiment, the locational relation between the first time-domain resource block and the time-domain resources occupied by the first signaling in time domain comprises that the second time-domain resource block comprises the time-domain resources occupied by the first signaling in time domain, and the second time-domain resource block is before the first time-domain resource block.

In one embodiment, the locational relation between the first time-domain resource block and the time-domain resources occupied by the first signaling in time domain comprises that the second time-domain resource block comprises the time-domain resources occupied by the first signaling in time domain, and the second time-domain resource block is earlier than the first time-domain resource block.

In one embodiment, the locational relation between the first time-domain resource block and the time-domain resources occupied by the first signaling in time domain refers to whether any of the at least one multicarrier symbol comprised in the time-domain resources occupied by the first signaling in time domain belongs to the first time-domain resource block.

In one embodiment, the locational relation between the first time-domain resource block and the time-domain resources occupied by the first signaling in time domain refers to whether the first time-domain resource block comprises any multicarrier symbol in the time-domain resources occupied by the first signaling in time domain.

In one embodiment, the configuration of the first reference signal resource is related to the locational relation between the first time-domain resource block and the time-domain resources occupied by the first signaling in time domain.

In one embodiment, the number of symbol(s) of the first reference signal resource is related to the locational relation between the first time-domain resource block and the time-domain resources occupied by the first signaling in time domain.

In one embodiment, the first time-domain resource block comprises the time-domain resources occupied by the first signaling in time domain, and the number of symbol(s) of the first reference signal resource is the first number of symbol(s).

In one embodiment, the first time-domain resource block does not comprise the time-domain resources occupied by the first signaling in time domain, and the number of symbol(s) of the first reference signal resource is the second number of symbol(s).

In one embodiment, the second time-domain resource block comprises the time-domain resources occupied by the first signaling in time domain, and the number of symbol(s) of the first reference signal resource is the second number of symbol(s).

In one embodiment, the first time-domain resource block comprises the time-domain resources occupied by the first signaling in time domain, and the number of symbol(s) of the first reference signal resource is the first number of symbol(s); or, the first time-domain resource block does not comprise the time-domain resources occupied by the first signaling in time domain, and the number of symbol(s) of the first reference signal resource is the second number of symbol(s).

In one embodiment, the first time-domain resource block comprises the time-domain resources occupied by the first signaling in time domain, and the number of symbol(s) of the first reference signal resource is the first number of symbol(s); or, the second time-domain resource block comprises the time-domain resources occupied by the first signaling in time domain, and the number of symbol(s) of the first reference signal resource is the second number of symbol(s).

In one embodiment, the time-domain resources occupied by the first signaling in time domain belong to the first time-domain resource block, and the number of symbol(s) of the first reference signal resource is the first number of symbol(s).

In one embodiment, the time-domain resources occupied by the first signaling in time domain do not belong to the first time-domain resource block, and the number of symbol(s) of the first reference signal resource is the second number of symbol(s).

In one embodiment, the time-domain resources occupied by the first signaling in time domain belong to the second time-domain resource block, and the number of symbol(s) of the first reference signal resource is the second number of symbol(s).

In one embodiment, the time-domain resources occupied by the first signaling in time domain belong to the first time-domain resource block, and the number of symbol(s) of the first reference signal resource is the first number of symbol(s); or, the time-domain resources occupied by the first signaling in time domain do not belong to the first time-domain resource block, and the number of symbol(s) of the first reference signal resource is the second number of symbol(s).

In one embodiment, the time-domain resources occupied by the first signaling in time domain belong to the first time-domain resource block, and the number of symbol(s) of the first reference signal resource is the first number of symbol(s); or, the time-domain resources occupied by the first signaling in time domain belong to the second time-domain resource block, and the number of symbol(s) of the first reference signal resource is the second number of symbol(s).

In one embodiment, the locational relation between the first time-domain resource block and the time-domain resources occupied by the first signaling in time domain is used to determine the configuration of the first reference signal resource.

In one embodiment, the locational relation between the first time-domain resource block and the time-domain resources occupied by the first signaling in time domain is used to determine the number of symbol(s) of the first reference signal resource.

In one embodiment, when the first time-domain resource block comprises the time-domain resources occupied by the first signaling in time domain, the number of symbol(s) of the first reference signal resource is the first number of symbol(s); when the first time-domain resource block does not comprise the time-domain resources occupied by the first signaling in time domain, the number of symbol(s) of the first reference signal resource is the second number of symbol(s).

In one embodiment, when the first time-domain resource block comprises the time-domain resources occupied by the first signaling in time domain, the number of symbol(s) of the first reference signal resource is the first number of symbol(s); when the second time-domain resource block comprises the time-domain resources occupied by the first signaling in time domain, the number of symbol(s) of the first reference signal resource is the second number of symbol(s).

In one embodiment, when the time-domain resources occupied by the first signaling in time domain belong to the first time-domain resource block, the number of symbol(s) of the first reference signal resource is the first number of symbol(s); when the time-domain resources occupied by the first signaling in time domain do not belong to the first time-domain resource block, the number of symbol(s) of the first reference signal resource is the second number of symbol(s).

In one embodiment, when the time-domain resources occupied by the first signaling in time domain belong to the first time-domain resource block, the number of symbol(s) of the first reference signal resource is the first number of symbol(s); when the time-domain resources occupied by the first signaling in time domain belong to the second time-domain resource block, the number of symbol(s) of the first reference signal resource is the second number of symbol(s).

In one embodiment, the first number of symbol(s) is a positive integer less than 14.

In one embodiment, the second number of symbol(s) is a positive integer less than 14.

In one embodiment, the first number of symbol(s) is not equal to the second number of symbol(s).

In one embodiment, the first number of the symbol(s) is less than the second number of symbol(s).

In one embodiment, the first number of the symbol(s) is greater than the second number of symbol(s).

### Embodiment 8

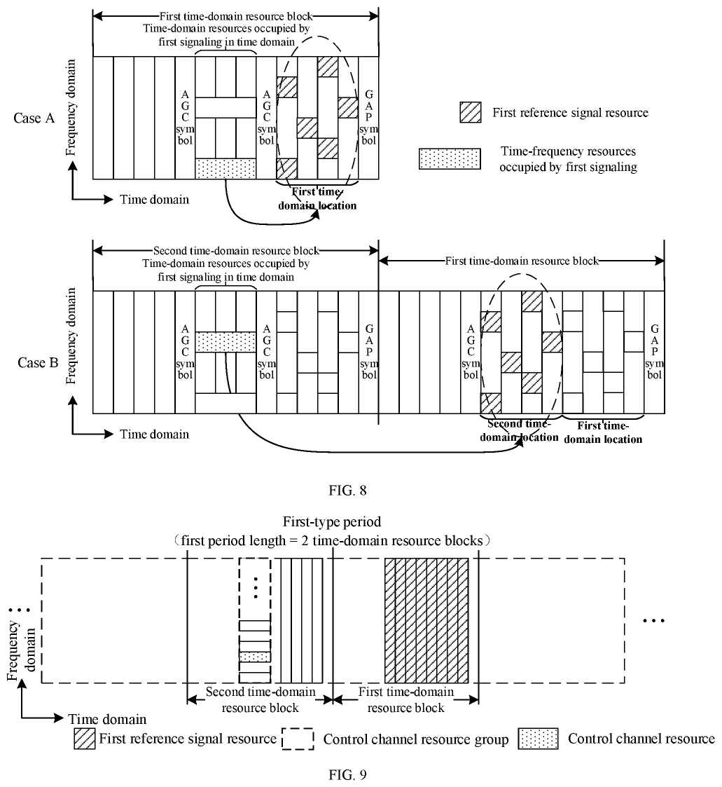

Embodiment 8 illustrates a schematic diagram of a relation between a configuration of a first reference signal resource as well as a first time-domain resource block and time-domain resources occupied by a first signaling in time domain according to one embodiment of the present application, as shown in FIG. 8. In FIG. 8, the long rectangle marked by “AGC symbol” represents a multicarrier symbol used for Automatic Gain Control (AGC); the long rectangle marked by “GAP symbol” represents a guard interval; the dot-filled rectangle represents time-frequency resources occupied by the first signaling; the slash-filled square represents an RE occupied by the first reference signal resource.

In embodiment 8, the first resource pool comprises the first time-domain resource block; time-domain resources comprised in the first reference signal resource belong to the first time-domain resource block; time-domain resources occupied by the first signaling in time domain belong to a time-domain resource block in the first resource pool; a configuration of a first reference signal resource comprises a time-domain location of the first reference signal resource in the first time-domain resource block, and the time-domain location of the first reference signal resource in the first time-domain resource block is related to a locational relation between the first time-domain resource block and the time-domain resources occupied by the first signaling in time domain; in case A of embodiment 8, the time-domain resources occupied by the first signaling in time domain belong to the first time-domain resource block, the time-domain location of the first reference signal resource in the first time-domain resource block is a first time-domain location; in case B of embodiment 8, the time-domain resources occupied by the first signaling in time domain belong to the second time-domain resource block, the time-domain location of the first reference signal resource in the first time-domain resource block is a second time-domain location; the second time-domain location is earlier than the first time-domain location.

In one embodiment, the time-domain location of the first reference signal resource in the first time-domain resource block refers to a multicarrier symbol occupied by the first reference signal resource in the first time-domain resource block.

In one embodiment, the time-domain location of the first reference signal resource in the first time-domain resource block refers to an index of a multicarrier symbol occupied by the first reference signal resource in the first time-domain resource block.

In one embodiment, the time-domain location of the first reference signal resource in the first time-domain resource block comprises an index of any multicarrier symbol occupied by the first reference signal resource in the first time-domain resource block.

In one embodiment, the time-domain location of the first reference signal resource in the first time-domain resource block comprises an index of a first one of multicarrier symbols occupied by the first reference signal resource in the first time-domain resource block.

In one embodiment, the time-domain location of the first reference signal resource in the first time-domain resource block comprises an index of a last one of multicarrier symbols occupied by the first reference signal resource in the first time-domain resource block.

In one embodiment, the time-domain location of the first reference signal resource in the first time-domain resource block is one of a first time-domain location or a second time-domain location.

In one embodiment, the time-domain location of the first reference signal resource in the first time-domain resource block is the first time-domain location.

In one embodiment, the time-domain location of the first reference signal resource in the first time-domain resource block is the second time-domain location.

In one embodiment, the first time-domain location is different from the second time-domain location.

In one embodiment, the first time-domain location is before the second time-domain location.

In one embodiment, the second time-domain location is earlier than the first time-domain location.

In one embodiment, the first time-domain location comprises at least one multicarrier symbol.

In one embodiment, the second time-domain location comprises at least one multicarrier symbol.

In one embodiment, the first time-domain location comprises at least one multicarrier symbol in the first time-domain resource block.

In one embodiment, the second time-domain location comprises at least one multicarrier symbol in the first time-domain resource block.

In one embodiment, at least one multicarrier symbol in the second time-domain location is before any multicarrier symbol in the first time-domain location.

In one embodiment, at least one multicarrier symbol in the second time-domain location is earlier than any multicarrier symbol in the first time-domain location.

In one embodiment, any multicarrier symbol in the second time-domain location is before any multicarrier symbol in the first time-domain location.

In one embodiment, any multicarrier symbol in the second time-domain location is earlier than any multicarrier symbol in the first time-domain location.

In one embodiment, the time-domain location of the first reference signal resource in the first time-domain resource block is related to the locational relation between the first time-domain resource block and the time-domain resources occupied by the first signaling in time domain.

In one embodiment, the first time-domain resource block comprises the time-domain resources occupied by the first signaling in time domain, and the time-domain location of the first reference signal resource in the first time-domain resource block is the first time-domain location.

In one embodiment, the first time-domain resource block does not comprise the time-domain resources occupied by the first signaling in time domain, and the time-domain location of the first reference signal resource in the first time-domain resource block is the second time-domain location.

In one embodiment, the second time-domain resource block comprises the time-domain resources occupied by the first signaling in time domain, and the time-domain location of the first reference signal resource in the first time-domain resource block is the second time-domain location.

In one embodiment, the first time-domain resource block comprises the time-domain resources occupied by the first signaling in time domain, and the time-domain location of the first reference signal resource in the first time-domain resource block is the first time-domain location; or, the first time-domain resource block does not comprise the time-domain resources occupied by the first signaling in time domain, and the time-domain location of the first reference signal resource in the first time-domain resource block is the second time-domain location.

In one embodiment, the first time-domain resource block comprises the time-domain resources occupied by the first signaling in time domain, and the time-domain location of the first reference signal resource in the first time-domain resource block is the first time-domain location; or, the second time-domain resource block comprises the time-domain resources occupied by the first signaling in time domain, and the time-domain location of the first reference signal resource in the first time-domain resource block is the second time-domain location.

In one embodiment, the time-domain resources occupied by the first signaling in time domain belong to the first time-domain resource block, and the time-domain location of the first reference signal resource in the first time-domain resource block is the first time-domain location.

In one embodiment, the time-domain resources occupied by the first signaling in time domain do not belong to the first time-domain resource block, and the time-domain location of the first reference signal resource in the first time-domain resource block is the second time-domain location.

In one embodiment, the time-domain resources occupied by the first signaling in time domain belong to the second time-domain resource block, and the time-domain location of the first reference signal resource in the first time-domain resource block is the second time-domain location.

In one embodiment, the time-domain resources occupied by the first signaling in time domain belong to the first time-domain resource block, and the time-domain location of the first reference signal resource in the first time-domain resource block is the first time-domain location; or, the time-domain resources occupied by the first signaling in time domain do not belong to the first time-domain resource block, and the time-domain location of the first reference signal resource in the first time-domain resource block is the second time-domain location.

In one embodiment, the time-domain resources occupied by the first signaling in time domain belong to the first time-domain resource block, and the time-domain location of the first reference signal resource in the first time-domain resource block is the first time-domain location; or, the time-domain resources occupied by the first signaling in time domain belong to the second time-domain resource block, and the time-domain location of the first reference signal resource in the first time-domain resource block is the second time-domain location.

In one embodiment, the locational relation between the first time-domain resource block and the time-domain resources occupied by the first signaling in time domain is used to determine the time-domain location of the first reference signal resource in the first time-domain resource block.

In one embodiment, when the first time-domain resource block comprises the time-domain resources occupied by the first signaling in time domain, the time-domain location of the first reference signal resource in the first time-domain resource block is the first time-domain location; when the first time-domain resource block does not comprise the time-domain resources occupied by the first signaling in time domain, the time-domain location of the first reference signal resource in the first time-domain resource block is the second time-domain location.

In one embodiment, when the first time-domain resource block comprises the time-domain resources occupied by the first signaling in time domain, the time-domain location of the first reference signal resource in the first time-domain resource block is the first time-domain location; when the second time-domain resource block comprises the time-domain resources occupied by the first signaling in time domain, the time-domain location of the first reference signal resource in the first time-domain resource block is the second time-domain location.

In one embodiment, when the time-domain resources occupied by the first signaling in time domain belong to the first time-domain resource block, the time-domain location of the first reference signal resource in the first time-domain resource block is the first time-domain location; when the time-domain resources occupied by the first signaling in time domain do not belong to the first time-domain resource block, the time-domain location of the first reference signal resource in the first time-domain resource block is the second time-domain location.

In one embodiment, when the time-domain resources occupied by the first signaling in time domain belong to the first time-domain resource block, the time-domain location of the first reference signal resource in the first time-domain resource block is the first time-domain location; when the time-domain resources occupied by the first signaling in time domain belong to the second time-domain resource block, the time-domain location of the first reference signal resource in the first time-domain resource block is the second time-domain location.

### Embodiment 9

Embodiment 9 illustrates a schematic diagram of a relation between a first-type period and control channel resources according to one embodiment of the present application, as shown in FIG. 9. In FIG. 9, the dotted big rectangle represents a time-domain resource block in a first resource pool; a distance between two solid lines represents a first-type period; the solid dotted rectangle represents a control channel resource group; the dot-filled rectangle represents a control channel resource; the slash-filled long rectangle represents a first reference signal resource.

In embodiment 9, the first resource pool comprises multiple first-type periods, any of the multiple first-type periods comprised in the first resource pool comprises at least one time-domain resource block; any of the multiple first-type periods comprises one control channel resource group, and the control channel resource group comprised in any of the multiple first-type periods comprises at least one control channel resource; the first signaling occupies a control channel resource.

In one embodiment, the first resource pool comprises multiple control channel resource groups, and any of the multiple control channel resource groups comprised in the first resource pool comprises at least one control channel resource.

In one embodiment, the multiple control channel resource groups are Time Division Multiplexing (TDM).

In one embodiment, multiple control channel resources comprised in any of the multiple control channel resource groups are Frequency Division Multiplexed (FDM).

In one embodiment, the multiple first-type periods comprised in the first resource pool respectively comprise the multiple control channel resource groups.

In one embodiment, any of the multiple first-type periods comprised in the first resource pool only comprises one control channel resource group.

In one embodiment, the multiple control channel resource groups are respectively located in the multiple first-type periods.

In one embodiment, any of the multiple control channel resource groups only belongs to one of the multiple first-type periods.

In one embodiment, multiple control channel resources comprised in any of the multiple control channel resource groups belong to one of the multiple first-type periods.

In one embodiment, any two adjacent control channel resource groups in the multiple control channel resource groups are spaced by a first period length.

In one embodiment, the first period length is a positive integer.

In one embodiment, the first period length is a number of time-domain resource block(s) comprised in any of the multiple first-type periods comprised in the first resource pool.

In one embodiment, the first period length is one of 1, 2, 4 and 8.

In one embodiment, the first period length is equal to 1.

In one embodiment, the first period length is equal to 2.

In one embodiment, the first time-domain resource block and the second time-domain resource block belong to one of the multiple first-type periods.

In one embodiment, both the first time-domain resource block and the second time-domain resource block are located in one of the multiple first-type periods.

In one embodiment, any of the multiple control channel resource groups occupies one time-domain resource block in one of the multiple first-type periods.

In one embodiment, any of the multiple control channel resource groups occupies at least one multicarrier symbol in one time-domain resource block in one of the multiple first-type periods.

In one embodiment, any of the multiple control channel resource groups occupies at least one multicarrier symbol, and the at least one multicarrier symbol occupied by any of the multiple control channel resource groups belongs to one time-domain resource block in one of the multiple first-type periods.

In one embodiment, any control channel resource comprised in any of the multiple control channel resource groups occupies multiple frequency-domain resource blocks in frequency domain.

In one embodiment, any control channel resource comprised in any of the multiple control channel resource groups occupies multiple frequency-domain resource blocks in the first resource pool in frequency domain.

In one embodiment, any control channel resource comprised in any of the multiple control channel resource groups occupies multiple PRBs in frequency domain.

In one embodiment, any control channel resource comprised in any of the multiple control channel resource groups belongs to one frequency-domain resource block in the first resource pool in frequency domain.

In one embodiment, any control channel resource comprised in any of the multiple control channel resource groups belongs to one sub-channel in the first resource pool in frequency domain.

In one embodiment, the control channel resources occupied by the first signaling are control channel resources in a control channel resource group among the multiple control channel resources groups.

In one embodiment, the control channel resources occupied by the first signaling are used to determine the first reference signal resource.

In one embodiment, the control channel resources occupied by the first signaling are used to determine a time-domain resource block to which the first reference signal resource belongs.

In one embodiment, the control channel resources occupied by the first signaling are used to determine the first time-domain resource block from the first resource pool.

In one embodiment, the control channel resources occupied by the first signaling are used to determine the first time-domain resource block from multiple time-domain resource blocks comprised in the first-type period.

In one embodiment, the control channel resources occupied by the first signaling are used to determine the configuration of the first reference signal resource.

In one embodiment, a position of the control channel resources occupied by the first signaling in a control channel resource group is used to determine the first reference signal resource.

In one embodiment, an index of the control channel resources occupied by the first signaling in a control channel resource group is used to determine the first reference signal resource.

In one embodiment, a position of the control channel resources occupied by the first signaling in a control channel resource group is used to determine the first time-domain resource block.

In one embodiment, an index of the control channel resources occupied by the first signaling in a control channel resource group is used to determine the first time-domain resource block.

In one embodiment, a position of the control channel resources occupied by the first signaling in a control channel resource group is used to determine the first time-domain resource block from multiple time-domain resource blocks comprised in the first-type period.

In one embodiment, an index of the control channel resources occupied by the first signaling in a control channel resource group is used to determine the first time-domain resource block from multiple time-domain resource blocks comprised in the first-type period.

In one embodiment, a position of the control channel resources occupied by the first signaling in a control channel resource group is used to determine the configuration of the first reference signal resource.

In one embodiment, an index of the control channel resources occupied by the first signaling in a control channel resource group is used to determine the configuration of the first reference signal resource.

In one embodiment, frequency-domain resources occupied by the first signaling in frequency domain belong to one of the multiple frequency-domain resource blocks comprised in the first resource pool.

In one embodiment, frequency-domain resources occupied by the first signaling in frequency domain comprise multiple frequency-domain resource blocks in the first resource pool.

In one embodiment, one of the multiple frequency-domain resource blocks comprised in the first resource pool to which frequency-domain resources occupied by the first signaling in frequency domain belong is a sub-channel.

In one embodiment, multiple frequency-domain resource blocks in the first resource pool comprised in frequency-domain resources occupied by the first signaling in frequency domain are respectively multiple PRBs.

In one embodiment, the configuration of the first reference signal resource is related to the frequency-domain resources occupied by the first signaling in frequency domain.

In one embodiment, the frequency-domain resources occupied by the first signaling in frequency domain are used to determine the configuration of the first reference signal resource.

In one embodiment, the first time-domain resource block is related to the frequency-domain resources occupied by the first signaling in frequency domain.

In one embodiment, the frequency-domain resources occupied by the first signaling in frequency domain are used to determine the first time-domain resource block.

In one embodiment, the frequency-domain resources occupied by the first signaling in frequency domain are used to determine the first time-domain resource block from multiple time-domain resource blocks comprised in a first-type period.

In one embodiment, the frequency-domain resources occupied by the first signaling in frequency domain are frequency-domain resources comprised by the control channel resource occupied by the first signaling in frequency domain.

In one embodiment, the time-domain resources occupied by the first signaling in time domain are time-domain resources comprised in the control channel resource occupied by the first signaling in time domain.

### Embodiment 10

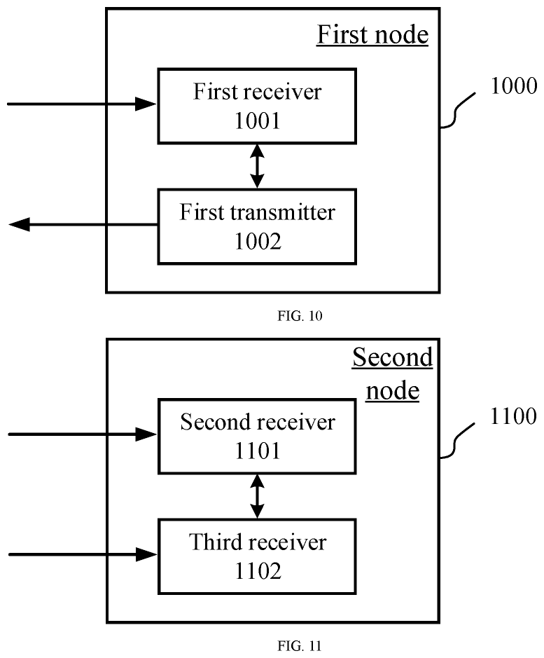

Embodiment 10 illustrates a structure block diagram of a processor in a first node, as shown in FIG. 10. In embodiment 10, a processor 1000 of a first node mainly consists of a first receiver 1001 and a first transmitter 1002.

In one embodiment, the first receiver 1001 comprises at least one of the antenna 452, the transmitter/receiver 454, the multi-antenna receiving processor 458, the receiving processor 456, the controller/5 processor 459, or the memory 460 in FIG. 4 of the present application.

In one embodiment, the first transmitter 1002 comprises at least one of the antenna 452, the transmitter/receiver 454, the multi-antenna transmitting processor 457, the transmitting processor 468, the controller/processor 459, the memory 460, or the data source 467 in FIG. 4 of the present application.

In embodiment 10, the first receiver 1001 receives a first information block, and the first information block is used to determine a first resource pool; the first transmitter 1002 transmits a first signaling, and the first signaling is used to determine a first time-domain resource block from the first resource pool; the first transmitter 1002 transmits a first positioning reference signal on a first reference signal resource; the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, time-domain resources occupied by the first signaling in time domain belong to one of the multiple time-domain resource blocks comprised in the first resource pool, and whether the time-domain resources occupied by the first signaling in time domain belong to the first time-domain resource block is used to determine the configuration of the first reference signal resource.

In one embodiment, a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

In one embodiment, a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

In one embodiment, the first resource pool comprises multiple frequency-domain resource blocks, and frequency-domain resources occupied by the first signaling in frequency domain belong to one of the multiple frequency-domain resource blocks comprised in the first resource pool; the configuration of the first reference signal resource is related to the frequency-domain resources occupied by the first signaling in frequency domain.

In one embodiment, the first information block indicates a first period length; the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups.

In one embodiment, the first time-domain resource block and the second time-domain resource block belong to a same first-type period among the multiple first-type periods.

In one embodiment, the first node 1000 is a UE.

In one embodiment, the first node 1000 is a relay node.

In one embodiment, the first node 1000 is a roadside device.

### Embodiment 11

Embodiment 11 illustrates a structure block diagram of a processor in a second node, as shown in FIG. 11. In embodiment 11, a processor 1100 in a second node mainly consists of a second receiver 1101 and a third receiver 1102.

In one embodiment, the second receiver 1101 comprises at least one of the antenna 420, the transmitter/receiver 418, the multi-antenna receiving processor 472, the receiving processor 470, the controller/processor 475 or the memory 476 in FIG. 4 of the present application.

In one embodiment, the third receiver 1102 comprises at least one of the antenna 420, the transmitter/receiver 418, the multi-antenna receiving processor 472, the receiving processor 470, the controller/processor 475 or the memory 476 in FIG. 4 of the present application.

In embodiment 11, the second receiver 1101 receives a second information block, and the second information block is used to determine a first resource pool; the third receiver receives a first signaling, the first signaling is used to determine a first time-domain resource block from the first resource pool; the third receiver 1102 receives a first positioning reference signal on a first reference signal resource; the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

In one embodiment, time-domain resources occupied by the first signaling in time domain belong to one of the multiple time-domain resource blocks comprised in the first resource pool, and whether the time-domain resources occupied by the first signaling in time domain belong to the first time-domain resource block is used to determine the configuration of the first reference signal resource.

In one embodiment, a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

In one embodiment, a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

In one embodiment, the first resource pool comprises multiple frequency-domain resource blocks, and frequency-domain resources occupied by the first signaling in frequency domain belong to one of the multiple frequency-domain resource blocks comprised in the first resource pool; the configuration of the first reference signal resource is related to the frequency-domain resources occupied by the first signaling in frequency domain.

In one embodiment, the second information block indicates a first period length; the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups.

In one embodiment, the first time-domain resource block and the second time-domain resource block belong to a same first-type period among the multiple first-type periods.

In one embodiment, the second node 1100 is a UE.

In one embodiment, the second node 1100 is a relay node.

In one embodiment, the second node 1100 is a roadside device.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, eMTC terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, eMTC terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first information block, the first information block being used to determine a first resource pool;
a first transmitter, transmitting a first signaling, the first signaling being used to determine a first time-domain resource block from the first resource pool; and
the first transmitter, transmitting a first positioning reference signal on a first reference signal resource;
wherein the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

2. The first node according to claim 1, wherein time-domain resources occupied by the first signaling in time domain belong to one of the multiple time-domain resource blocks comprised in the first resource pool, and whether the time-domain resources occupied by the first signaling in time domain belong to the first time-domain resource block is used to determine the configuration of the first reference signal resource.

3. The first node according to claim 1, wherein a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

4. The first node according to claim 1, wherein a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

5. The first node according to claim 1, wherein the first resource pool comprises multiple frequency-domain resource blocks, and frequency-domain resources occupied by the first signaling in frequency domain belong to one of the multiple frequency-domain resource blocks comprised in the first resource pool; the configuration of the first reference signal resource is related to the frequency-domain resources occupied by the first signaling in frequency domain.

6. The first node according to claim 1, wherein the first information block indicates a first period length; the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups.

7. The first node according to claim 6, wherein the first time-domain resource block and the second time-domain resource block belong to a same first-type period among the multiple first-type periods.

8. A second node for wireless communications, comprising:
a second receiver, receiving a second information block, the second information block being used to determine a first resource pool;
a third receiver, receiving a first signaling, the first signaling being used to determine a first time-domain resource block from the first resource pool; and
the third receiver, receiving a first positioning reference signal on a first reference signal resource;
wherein the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

9. The second node according to claim 8, wherein time-domain resources occupied by the first signaling in time domain belong to one of the multiple time-domain resource blocks comprised in the first resource pool, and whether the time-domain resources occupied by the first signaling in time domain belong to the first time-domain resource block is used to determine the configuration of the first reference signal resource.

10. The second node according to claim 8, wherein a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

11. The second node according to claim 8, wherein a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

12. The second node according to claim 8, wherein the second information block indicates a first period length; the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups.

13. The second node according to claim 12, wherein the first time-domain resource block and the second time-domain resource block belong to a same first-type period among the multiple first-type periods.

14. A method in a first node for wireless communications, comprising:
receiving a first information block, the first information block being used to determine a first resource pool;
transmitting a first signaling, the first signaling being used to determine a first time-domain resource block from the first resource pool; and
transmitting a first positioning reference signal on a first reference signal resource;
wherein the first resource pool comprises multiple time-domain resource blocks, the first time-domain resource block is one of the multiple time-domain resource blocks comprised in the first resource pool, and the first reference signal resource belongs to the first time-domain resource block in time domain; the first reference signal resource comprises at least one multicarrier symbol in time domain, a configuration of the first reference signal resource is related to a locational relation between the first time-domain resource block and time-domain resources occupied by the first signaling in time domain, and the configuration of the first reference signal resource comprises at least one of a number of symbol(s) for the first reference signal resource and a time-domain location of the first reference signal resource in the first time-domain resource block.

15. The method in a first node according to claim 14, wherein time-domain resources occupied by the first signaling in time domain belong to one of the multiple time-domain resource blocks comprised in the first resource pool, and whether the time-domain resources occupied by the first signaling in time domain belong to the first time-domain resource block is used to determine the configuration of the first reference signal resource.

16. The method in a first node according to claim 14, wherein a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, the number of symbol(s) of the first reference signal resource is a first number of symbol(s); when the time-domain resources occupied by the first signaling in time domain belong to the second time-domain resource block, the number of symbol(s) of the first reference signal resource is a second number of symbol(s); the first number of symbol(s) is less than the second number of symbol(s).

17. The method in a first node according to claim 14, wherein a second time-domain resource block is a time-domain resource block before the first time-domain resource block among the multiple time-domain resource blocks comprised in the first resource pool, and the time-domain resources occupied by the first signaling in time domain belong to one of the first time-domain resource block or the second time-domain resource block; when the time-domain resources occupied by the first signaling in time domain belong to the first time-domain resource block, a time-domain location of the first reference signal resource in the first time-domain resource block is a first time-domain location; when the time-domain resources occupied by the first signaling in time domain belong to the second time-domain resource block, a time-domain location of the first reference signal resource in the first time-domain resource block is a second time-domain location; the second time-domain location is earlier than the first time-domain location.

18. The method in a first node according to claim 14, wherein the first resource pool comprises multiple frequency-domain resource blocks, and frequency-domain resources occupied by the first signaling in frequency domain belong to one of the multiple frequency-domain resource blocks comprised in the first resource pool; the configuration of the first reference signal resource is related to the frequency-domain resources occupied by the first signaling in frequency domain.

19. The method in a first node according to claim 14, wherein the first information block indicates a first period length;
the first resource pool comprises multiple first-type periods, any of the multiple first-type periods comprised in the first resource pool comprises at least one time-domain resource block, and the first period length is a number of time-domain resource block(s) comprised in any first-type period in the first resource pool; the multiple first-type periods respectively comprise multiple control channel resource groups, any of the multiple control channel resource groups only belongs to a time-domain resource block in one of the multiple first-type periods in time domain, and any of the multiple control channel resource groups comprises at least one control channel resource; the first signaling occupies one control channel resource in the multiple control channel resource groups.

20. The method in a first node according to claim 19, wherein the first time-domain resource block and the second time-domain resource block belong to a same first-type period among the multiple first-type periods.
